(19) United States
(12) Patent Application Publication
(10) Pub. No.: US 2022/0066928 A1
(43) Pub. Date: Mar. 3, 2022

(54) POOLED MEMORY CONTROLLER FOR THIN-PROVISIONING DISAGGREGATED MEMORY

(71) Applicant: Microsoft Technology Licensing, LLC, Redmond, WA (US)

(72) Inventors: Siamak TAVALLAEI, Spring, TX (US); Ishwar AGARWAL, Redmond, WA (US)

(73) Assignee: Microsoft Technology Licensing, LLC, Redmond, WA (US)

(21) Appl. No.: 17/010,548

(22) Filed: Sep. 2, 2020

(51) Int. Cl. G06F 12/06; G06F 13/16; G06F 9/4401; G06N 20/00

(52) U.S. Cl. CPC G06F 12/0646; G06F 13/1605; G06F 2212/251; G06N 20/00; G06F 9/4403

(57) ABSTRACT

A thin-provisioned multi-node computer system comprising a disaggregated memory pool and a pooled memory controller. The disaggregated memory pool is configured to make a shared memory capacity available to each of a plurality of compute nodes. The pooled memory controller is configured to assign, to each compute node of the plurality of compute nodes, a portion of the disaggregated memory pool such that a currently assigned total of assigned portions of the disaggregated memory pool is less than the shared memory capacity. The pooled memory controller is further configured to receive a request to assign an additional portion of the disaggregated memory pool such that the currently assigned total and the additional portion would exceed a predefined threshold amount of the shared memory capacity, to un-assign an assigned portion of the disaggregated memory pool, and assign the additional portion of the disaggregated memory pool.

### BACKGROUND

Data centers typically include large numbers of discrete compute nodes, such as server computers or other suitable computing devices. The compute nodes may utilize a variable amount of memory, such that actual usage often is significantly below total capacity.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A thin-provisioned, multi-node computer system comprises a disaggregated memory pool and a pooled memory controller managing an amount of physical memory. The disaggregated memory pool is configured to make a shared memory capacity (i.e., the memory managed by the controller) available to each of a plurality of compute nodes. The pooled memory controller is configured to assign, to each compute node of the plurality of compute nodes, a portion of the disaggregated memory pool such that a currently assigned total of memory in the disaggregated memory pool is often less than the shared memory capacity. The pooled memory controller is further configured to receive a request to assign an additional portion of the disaggregated memory pool to requesting a compute node of the compute nodes. In the event that such a request or other conditions would cause the pool usage to exceed a predefined threshold amount of the shared memory capacity, the system is configured to un-assign one or more assigned portions of the disaggregated memory pool before fulfilling requests to use more of the pool.

### BRIEF DESCRIPTION OF THE DRAWINGS

FIG. 1 schematically depicts a plurality of compute nodes coupled with a disaggregated memory pool.

FIG. 2 illustrates an example method for maintaining memory assignments for a plurality of compute nodes sharing the disaggregated memory pool.

FIG. 3 schematically depicts an example memory assignment for a plurality of compute nodes sharing a disaggregated memory pool.

FIG. 4 schematically depicts updating the memory assignment of FIG. 3 for compute nodes sharing the disaggregated memory pool.

FIG. 5 schematically depicts a requested additional memory assignment from a compute node that would markedly increase pressure on the disaggregated memory pool, for example causing total assignments to exceed a predefined threshold amount.

FIG. 6 schematically depicts un-assignment of pool memory to facilitate horning a compute node's request for additional pool memory.

FIG. 7 schematically depicts un-assignment of memory from a compute node by page-swapping a portion of assigned memory into an extended bulk memory.

FIG. 8 schematically depicts a plurality of different warning signals corresponding to varying degrees of pressure on a disaggregated memory pool.

FIG. 9 schematically shows an example computing system.

### DETAILED DESCRIPTION

As discussed above, data centers often have large numbers of server computers or other discrete compute nodes. Such compute nodes may be referred to as “host computing devices,” or “hosts,” as they may in some cases be used to host a plurality of virtual machines. It will be understood, however, that a compute node may be used for any suitable computing purpose, and need not be used for hosting virtual machines specifically. Furthermore, a host may itself be a virtual machine for purposes of the memory pool scenarios discussed herein. A host/node typically is configured with a designated memory allocation (e.g., 1 GB, 8 GB, 1 TB, 8 TB, or any other suitable memory allocation). Such allocation is essentially a characterization of the directly accessible memory for the node that is exposed to the operating system and applications. The designated memory allocation may be provided in part by memory natively attached to a discrete node or machine hosting a node, and in part via use of a pooled memory resource that may be associated with multiple different nodes.

Depending on the specific implementation, each individual compute node may have or be supported by any suitable assemblage of computer hardware. In conventional settings, servers are often provisioned to be substantially self-sufficient, with processing resources, data storage, memory, network interface componentry, power supplies, cooling, etc., so as to enable operation without any need to tap external resources. That said, blade servers or rack nodes sometimes omit cooling, power or other low-level infrastructure, with that functionality being offloaded to shared components that service multiple nodes.

In multi-node settings, workload can vary considerably from node to node. For example, a subset of data center nodes may be tasked with resource-intensive workloads, while other nodes sit relatively idle. Thus, despite some high localized activity, total resource consumption may be relatively low and, due to the way nodes are configured, resources at an idle load cannot be “loaned to” or otherwise consumed by compute nodes where activity is high. This inability to make use of idle resources is inefficient, and is sometimes referred to as “resource stranding.” In other words, resources that could potentially be applied to computing tasks are instead stranded in idle or underutilized hosts.

More particularly, with respect to volatile memory, stranding of the memory resource occurs when the average memory consumption/usage is less than the amount of natively-attached memory. For example, if a blade server is provisioned with 512 GB of natively-attached memory, statistical actual usage of 128 GB of memory constitutes significant stranding of the memory resource. This type of inefficiency can be dramatic when scaled across a large number of nodes.

Stranding can be mitigated when hardware resources are pulled out of individual compute nodes and are instead “disaggregated” as separate resource pools that can be flexibly accessed by connected compute nodes. The present disclosure primarily contemplates scenarios in which volatile memory hardware (e.g., random-access memory (RAM)) is disaggregated into a memory pool, and is managed to allow it to be flexibly used by any of a plurality of compute nodes—e.g., in a data center. This serves to alleviate resource stranding, as compute nodes are free to request memory when needed, and release such memory when no longer needed.

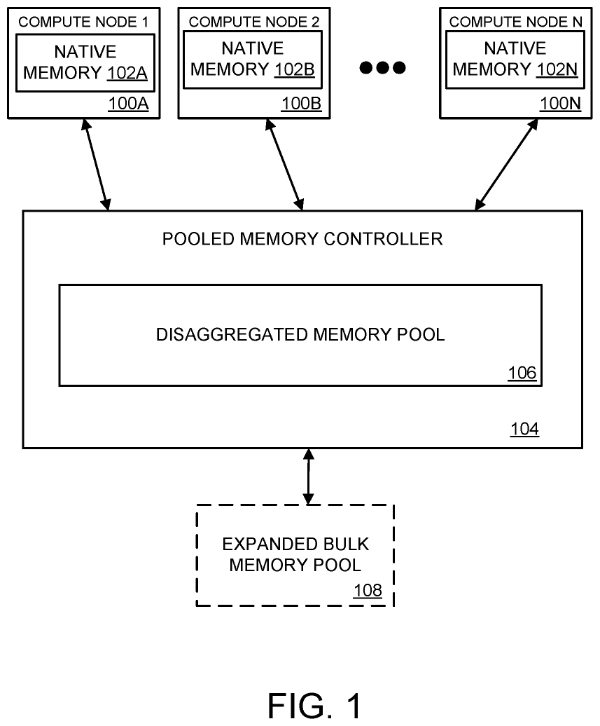

This is schematically illustrated with respect to FIG. 1. As shown, a plurality of compute nodes 100A-100N (where N is any suitable positive integer, e.g., tens, hundreds, thousands, millions, or more) are coupled with a pooled memory controller 104 that manages access to memory resources in a disaggregated memory pool 106. Disaggregated memory pool 106 is configured to make a shared memory capacity (e.g., 1 TB of memory or any other suitable amount of memory) available to each of a plurality of compute nodes (e.g., in addition to native memory capacity of the compute nodes). As discussed in more detail below, an important aspect of interaction between the compute nodes 100 and memory controller 104 is to intelligently manage the pooled memory resource and avoid undue pressure that would impede flexibly assigning pooled memory to nodes that need additional capacity.

In some examples, each compute node may have a natively-attached memory (e.g., native memory 102A of compute node 100A, native memory 102B of node 100B, and native memory 102N of node 100N). Natively-attached memory may be of any suitable size. In some examples, natively-attached memory may be fault-tolerant (e.g., utilizing redundant-array of independent disks (RAID) techniques). Accordingly, a compute node may be configured to preferentially utilize fault-tolerant native memory for fault-sensitive code and/or data. In various examples, dozens, hundreds, thousands, or more individual compute nodes may share access to one or more disaggregated resource pools, including disaggregated memory pool 106.

In some examples, the plurality of compute nodes may each be operatively coupled to pooled memory controller 104 via a high-speed and/or high-throughput bus, e.g., via a photonic interconnect. For example, a photonic interconnect may substantially reduce latency associated with accessing the disaggregated memory pool 106 by the compute nodes 100A-100N, even when such access is moderated by pooled memory controller 104. In some examples, the photonic interconnect may permit access to the disaggregated memory pool 106 with minimal latency relative to accessing native memory, e.g., in zero, one, two, or another suitably small number of additional non-uniform memory access (NUMA) hops relative to accessing the native memory. In some examples, a memory-side cache may be incorporated, for example on a memory controller 104, to reduce latency associated with a node reading/writing to pool memory. In some examples, one or more compute nodes of the plurality of compute nodes may include a NUMA-aware memory controller configured to optimize a memory slice layout among one or more of native memory of the compute node, the disaggregated memory pool 106, and/or the expanded bulk memory pool 108. For example, a compute node may be configured to store data that may be frequently accessed in a location within a relatively smaller number of NUMA hops (e.g., in native memory or in the disaggregated memory pool) and to store data that may be less frequently accessed in a location within a larger number of NUMA hops (e.g., in the expanded bulk memory pool).

In some examples, pooled memory controller 104 may include one or more compute express link (CXL)-compliant pooled memory controllers (CPMCs). In some examples, disaggregated memory pool 106 may be implemented using any suitable type of volatile RAM—e.g., Double Data Rate Synchronous Dynamic RAM (DDR SDRAM). Pooled memory controller 104 may facilitate utilization of the disaggregated memory pool 106 by any or all of the various compute nodes 100A-100N. It will be understood that a disaggregated memory pool may include any suitable number of physical memory units, corresponding to any suitable total memory capacity, and may be governed by one or more different memory control systems. A node in some cases may be confined to using memory behind an individual memory controller 104, or multiple pool segments may be employed, whereas “segment” refers to memory managed by an individual memory controller.

In many examples, the amount of memory collectively allocated to the plurality of compute nodes may exceed the total native and pooled memory that is available. This is sometimes referred to as “thin provisioning.” In general, in data center environments without thin provisioning, it can be observed that individual compute nodes (and/or virtual machines implemented on the compute nodes) are often provisioned with substantially more resources (e.g., storage space, memory) than the compute nodes end up actually using, statistically over time.

In general, an individual compute node may include a native memory controller and/or other controllers, buses, etc., configured for addressing/accessing native memory. A native memory controller may be configured to determine when a memory access (e.g., read or write) addresses into native memory (i.e., local to and tightly coupled to the resources of the compute node), and thereby handle such access without external reference to the disaggregated memory pool. Furthermore, the native memory controller may be “pool-aware” and configured to determine when a memory access references memory in the disaggregated memory pool. To handle such memory accesses, pool-aware subcomponents of the native memory controller (e.g., via hardware, firmware, and/or software) coordinate as needed to access memory slices managed by the pooled memory controller. In general, software running on the compute node, including the OS, may be largely or totally unaware of the specific location of the accessed memory (e.g., native memory vs. assigned memory from the pool), while still being configured to see a total memory allocation that includes both native and pooled memory. Accordingly, software running on the compute node may be completely oblivious and/or agnostic to the specific distribution of allocated memory among native memory and disaggregated memory pool. The native memory controller and/or pooled memory controller may cooperate in any suitable fashion to implement functionality described herein, e.g., memory allocations, memory assignments, memory addressing, and/or memory accesses (e.g., reads and/or writes).

In one example scenario without thin provisioning, a disaggregated memory pool may include 1 TB (1024 GB) of total memory, which may be distributed evenly between eight compute nodes. Furthermore, each compute node may include 128 GB of natively-attached memory (e.g., native memory 102A, native memory 102B, and native memory 102N may each comprise 128 GB of memory local to a corresponding compute node). Thus, each compute node may be assigned 128 GB of memory of the disaggregated memory pool, while having a total of 256 GB of provisioned memory between the natively-attached memory and pooled memory. In aggregate, the eight compute nodes may have access to 2 TB of memory total, again between the natively-attached memory and pooled memory. In this example, as a result of the 128 GB of native memory and 128 GB of pooled memory, each node is allocated 256 GB of memory from the perspective of the node's internal OS and memory system. That is, the node “sees” 256 GB of available memory.

However, it is generally unlikely that each compute node will fully utilize its memory allocation. Rather, in a more common scenario, each compute node may only use a maximum of 50% of its allocated memory during normal usage, and some compute nodes may use significantly less than 50%. As such, even though the 1 TB disaggregated memory pool will be fully assigned to the plurality of compute nodes, only a relatively small fraction of the pooled memory may be in use at any given time, and this represents an inefficient use of the available resources.

Given this, the amount of memory actually available—i.e., “provisioned”—in the memory pool could be reduced without significantly affecting performance of the plurality of compute nodes. For instance, the memory space of each compute node could still be constructed so that the pool portion of its memory allocation was 128 GB (thus amounting to 1 TB when summing the eight nodes), for example by providing an address range for 128 GB remote memory, however, the memory pool could be actually provisioned with only a total of 256 GB. Thus, the amount of allocated memory exceeds the amount of memory that is actually provisioned. In other words, while each compute node may be permitted to use up to 128 GB of pool memory as part of its 256 GB allocation, it is statistically likely that many compute nodes will not use all, or even a significant portion, of that 128 GB at any given time.

Furthermore, memory allocation needs may vary among different compute nodes (e.g., based on different memory requirements for different virtual machines, programs, and/or computing services). For example, a first virtual machine may allocate 1 TB of memory, whereas a second, different virtual machine may allocate 2 TB of memory. More generally, different virtual machine may allocate any suitable amount of memory as needed for different computational workloads. Thus, any unused memory assigned to one compute node may be reassigned to one or more of the other nodes. In this manner, any particular compute node may use up to 128 GB of pool memory if needed, while still conserving memory in the disaggregated pool, due to the fact that each compute node typically will not use 128 GB at any given time.

Such thin provisioning may be done to any suitable extent. It is generally beneficial in a multi-node grouping for the amount of available memory—native plus pooled—to exceed the amount of memory used by the compute nodes under typical circumstances. In other words, if the individual compute nodes on average use around 256 GB, then it normally would be desirable to have somewhat more than 256 GB of memory actually provisioned between the natively-attached memory and pooled memory, such that the compute nodes do not exhaust the available memory during normal use. In practice, however, any suitable amount of memory may be provisioned in the disaggregated memory pool, which may have any suitable relationship with the amount of memory allocated to the plurality of compute nodes.

An allocation for a compute node is a maximal amount of memory that compute node may use throughout operation. The allocation may have a corresponding address space size which may exceed physical memory available to the compute note at any given time. This sense of “availability” refers to the natively-attached memory, plus the amount of memory from the pool that is “assigned” for immediate/current use by the node, which during operation is normally less than the maximum amount of pool memory that could be assigned to the node per its allocation. In other words, the node is configured with a visible allocation of memory which corresponds to its natively attached memory plus a maximum amount of pool memory that has been “promised” to the node. The “assignment” of pool memory is a variable amount of memory from the pool that can range from zero up to the maximum amount of pool memory the node is allowed to use.

As just referenced, a compute node may request assignment of physical memory to provide a portion of the allocated address space (e.g., to increase memory usage). For example, the provided portion may include one or more “slices” of memory, where a slice refers to any contiguous portion of memory (e.g., a memory page or any other block of memory aligned to a slice size indicating a smallest granularity of portions of memory managed by the pooled memory controller, e.g., 1 GB slices, 2 GB slices, 8 GB slices, or any other suitable slice size). A memory controller as described herein may respond by providing the requesting compute node with access (e.g., reading and storing data) to one or more slices of physical memory managed by the pool controller.

The pooled memory controller is generally configured to manage disaggregated memory (pool memory directly managed by the controller, or external memory such as bulk failover memory or other pool segments managed by other controllers) to honor node assignment requests to assign memory up to the node's total allocation. It will be appreciated that in some examples (e.g., in memory pressure situations where pool usage is above threshold or, more severely, exceeding maximum capacity), the pooled memory controller may not be able to immediately provide physical memory for a requested assignment. Nevertheless, using the techniques of the present disclosure, the pooled memory controller may respond in various ways to pool pressure so as to honor valid requests for more pool memory. Memory pressure on the pool, as used herein, refers to instances in which the compute nodes attempt to collectively use more memory than is available in the disaggregated memory pool, or an amount of memory exceeding a threshold that may be predefined or otherwise determined.

Accordingly, the present disclosure discloses techniques for addressing scenarios where heightened demands are placed on pooled memory. In some examples, pooled memory controller 104 addresses memory pressure by revoking pool assignments from one or more compute nodes. Revocation may be based on assessment that compute nodes have a lower priority/need for pool memory currently assigned to them. In these or other examples, memory assignment requests may be routed to a different disaggregated memory pool segment that may still have available memory, i.e. pool memory managed by a different memory controller. For example, pooled memory controller 104 may be configured to route memory assignment requests to an expanded bulk memory pool 108. In some examples, pooled memory controller 104 may revoke or reduce a pool assignment, while also swapping data from revoked locations into another pool segment or into expanded bulk memory pool 108, so as to preserve the swapped-out data.

Although the present disclosure is described with regard to a plurality of compute nodes and a single pooled memory controller, it will be appreciated that a plurality of compute nodes may be configured to use multiple different pooled memory controllers. For example, the plurality of compute nodes may each be coupled to two different pooled memory controllers. Alternately or additionally, some compute nodes in a grouping may use a first pooled memory controller, with others using a second pooled memory controller. Multiple pooled memory controllers may be configured for any suitable purpose, e.g., to provide a larger pool of memory resources, to stripe memory assignments across multiple controllers (e.g., to provide redundancy and/or enhanced speed as in a RAID configuration, to provide failover in case of failure of one or more memory controllers and/or failure of associated memory hardware). In some examples, additional pooled memory controllers may be configured to provide an extended pool of disaggregated memory resources (e.g., with each memory controller managing a segment of the memory pool). For example, if a memory assignment would exceed the pre-defined threshold and/or capacity of the first pooled memory controller 104, subsequent assignments and/or data swapping may be done using memory resources provided by a different pooled memory controller (e.g., instead of or in addition to using expanded bulk memory pool as described herein).

Various references are made herein to a pre-defined usage threshold which corresponds to a level of memory pool pressure that triggers responsive actions. In some cases, a static threshold is used—e.g., a fixed amount of usage, a percentage of usage, an activity level. In other cases, the threshold may be dynamic based on operating conditions. For example, behavior patterns may be identified using machine learning models to determine when actionable pressure is placed on the memory pool. Still further, gradations may be employed to identify multiple degrees of memory pressure. In such a case, one set of countermeasures might be employed at a modest level of pressure, with more substantial interventions occurring at higher levels of pressure.

In some examples, expanded bulk memory pool 108 may be discrete from the compute nodes, and typically will have lower associated costs (e.g., financial cost for provisioning, spatial cost within a computing device footprint, and/or power cost for maintaining and/or accessing data within memory), thereby facilitating a larger capacity relative to disaggregated memory pool 106. Typically, expanded bulk memory pool 108 may generally have a higher latency for accessing stored data as compared to disaggregated memory pool 106. Non-limiting examples of memory technologies for expanded bulk memory pool 108 include hard disk, solid-state drive (SSD), and/or networked resources (e.g., network interface configured to interface with a spatially disparate computing device to access SDRAM memory, hard disk, and/or SSD resources associated with the spatially disparate computing device). In some examples, expanded bulk memory 108 may act as an expanded bulk memory pool for one or more different pooled memory controllers (e.g., pooled memory controller 104 and one or more additional pooled memory controllers associated with different sets of compute nodes may be configured to utilize different slices of expanded bulk memory 108 when necessary).

In some examples, each compute node may be pre-assigned some amount of memory capacity in the disaggregated memory pool, e.g., as the nodes are initialized or more generally at any operating state that temporally precedes another. If and when a particular compute node requests an expansion, the node may negotiate with the pooled memory controller 104 to determine whether and how much additional memory the node should be assigned from the disaggregated memory pool 106. For example, requesting an expansion and/or negotiating with the pooled memory controller 104 may be performed by a pool-aware subcomponent of the pooled memory controller. For example, if a compute node requests an assignment that would be within the pre-defined threshold and/or capacity (i.e., little or no pressure on the pool), the pooled memory controller 104 may simply provide the full assignment without pressure-mitigating interventions. Assignments to nodes in general will cause the node to stay at or below its memory allocation, which again is the maximum amount of memory exposed to the operating system/applications of the node.

Alternately, if the compute node requests an assignment that would exceed the pre-defined threshold and/or total memory capacity of the disaggregated memory pool 106 (i.e., pool pressure), the pooled memory controller 104 may make a determination as to whether undue pressure would occur (e.g., based on total assignments and/or total allocation that could result in future assignments of the compute node and other compute nodes). Accordingly, the pooled memory controller 104 may provide the full assignment when doing so would not likely result in undue memory pressure and/or exceed total memory capacity. When providing the full assignment may result in substantial memory pressure, the pooled memory controller 104 may be configured to provide an assignment using other memory resources (e.g., expanded bulk memory pool 108) and/or to reduce a memory assignment to another node before, after, or concurrent with providing the assignment.

The process of assigning additional memory to a node may include reducing the assignment reserved for another node and/or swapping assigned memory from disaggregated memory pool 106 into expanded bulk memory pool 108. In this manner, the amount of memory capacity available in the disaggregated pool may be carefully balanced and divided between the plurality of compute nodes in keeping with each node's actual needs, rather than allowing each compute node to seize pool capacity they have no need for.

In general, as described above, assigning additional memory may depend on any/or all of the following conditions: (1) whether unassigned capacity is relatively high, i.e., no memory pressure; (2) whether unassigned capacity is relatively low, i.e., memory pressure above a pre-defined threshold; or (3) whether there is insufficient memory capacity in the pool to immediately satisfy a node's request for additional assignment from the pool. When the pre-defined memory pressure threshold for the pool is exceeded, steps may be taken to reduce pool usage. In some examples, pressure may be relieved by pre-emptively un-assigning memory from compute nodes, i.e., “pre-emptive” in the sense that the intervention is not necessarily triggered by a node requesting more memory from the pool. This un-assignment can facilitate subsequent assignment of that memory without latency that might otherwise result, for example due to swapping data for nodes into expanded bulk memory 108 before using pool memory occupied by that data. In other examples, memory pressure may be relieved by shifting node memory usage to pool segments managed by other memory controllers. Furthermore, in some examples, memory pressure may be relieved and/or kept within tolerable limits by providing some, but not all, of a requested memory assignment. For example, if a 1 TB assignment would cause the total memory assignment to exceed a tolerable threshold but a 512 GB assignment would keep the total memory assignment within the tolerable threshold, the pooled memory controller may initially provide the 512 GB assignment. Accordingly, a requesting compute node may have a requested assignment partially fulfilled, while avoiding substantial memory pressure on the overall computing system. In some examples, after providing the 512 GB assignment, the memory controller may be configured to attempt to relieve memory pressure (e.g., by un-assigning memory using the techniques described herein) before and/or concurrently with providing the remaining memory out of the 1 TB requested.

The determination of which portions/slices of memory to un-assign due to a new assignment being requested may be based on any suitable determination pertaining to previous assignments and/or usage of pooled memory, e.g., according to a replacement policy for the disaggregated memory pool. For example, a portion of memory may be un-assigned from a node based on (1) recency and/or frequency of use (e.g., never-used slice, least-recently or least-frequently used slice(s)), (2) recency of assignment (e.g., least-recently assigned slice(s)), (4) a logical assessment of impact on future latencies, (5) an assessment latency/timing of transfer to bulk memory, etc.

Accordingly, the pooled memory controller 104 may minimize the potential of fully exhausting the memory resources provided by disaggregated memory pool 106, thereby easing upcoming assignments when nodes need more memory from the pool. In other words, if the total memory assignment exceeds the pre-defined threshold and/or approaches the total memory capacity (such as immediately following a successful memory assignment requested by a compute node), the pooled memory controller 104 may immediately and/or pre-emptively take steps to reduce the total assignments so that memory is generally available for any new assignment request.

Furthermore, when memory resource assignment exceeds the predefined threshold amount, a warning signal may be sent to one or more of the compute nodes, thereby facilitating steps by the one or more compute nodes to alleviate memory pressure on their own accord. For example, nodes may respond in any suitable manner to such warning signals, e.g., by de-allocating or relinquishing assigned memory, compressing data, moving data to an alternate storage device, closing memory-consuming applications, and/or avoiding or reducing an amount of subsequent allocations.

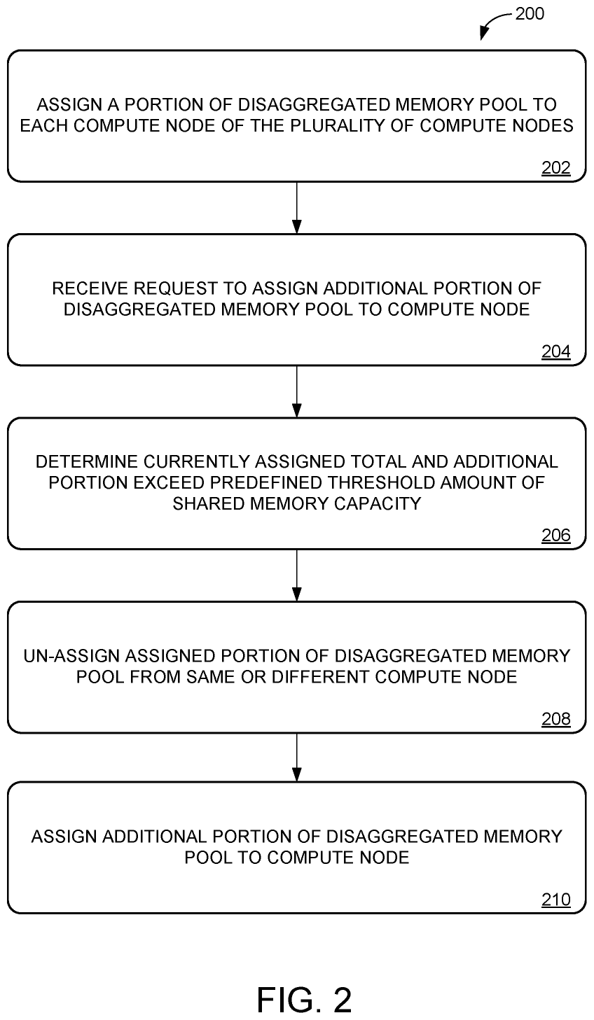

The pooled memory controller 104 may assign, un-assign, and otherwise manage memory resources in disaggregated memory pool 106 and/or expanded bulk memory pool 108 according to any suitable methodology. FIG. 2 shows an example method 200 that may be implemented by pooled memory controller 104.

At 202, method 200 includes assigning, to each compute node of the plurality of compute nodes, a portion (e.g., one or more slices) of the disaggregated memory pool such that a currently assigned total size of assigned slices of the disaggregated memory pool is less than the shared memory capacity. Such assignments may evolve over time. In any case, the depicted workflow contemplates a state in which compute nodes have been assigned various permissions to use a portion of the pool. In some cases, this assigned total is relatively low, such that requests for additional pool memory are routinely satisfied. In other cases of higher usage, various degrees of memory pressure may arise, which can trigger activity by the compute nodes and/or pool memory controller (or controllers) to reduce the pressure.

In some examples, the current assignment of the disaggregated memory pool may be an initial static assignment made during a boot process of a thin-provisioned multi-node computer system. For example, the pooled memory controller may be configured to assess a statistically likely amount of memory that would be utilized by each compute node during typical operation, so as to pre-assign each compute node a correspondingly suitable amount of the disaggregated memory pool. For example, the amount of memory suitable for a compute node may be based on a designated program to be executed by the compute node or another aspect of the compute node (e.g., based on an operating system, virtual machine, and/or service to be provided by the compute node). In some examples, the initial static assignment is based on a machine learning prediction of expected memory usage by each compute node of the plurality of compute nodes. Any suitable machine learning mechanism for predicting memory usage may be operated before and/or during the boot process or other operation. As a non-limiting example, a machine learning system may be trained based on historical data of various scenarios (e.g., various programs to be run on one or more compute nodes) to predict resource usage in each scenario.

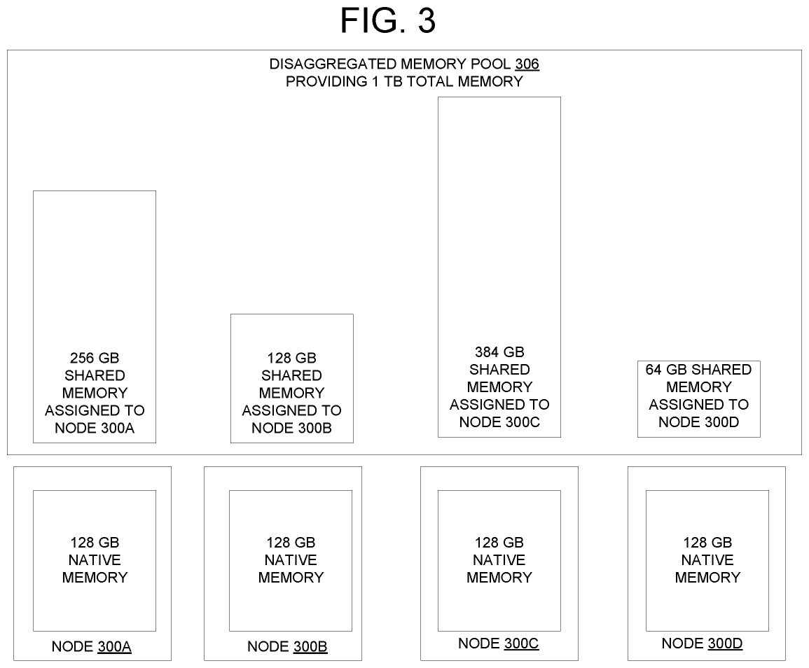

Turning briefly to FIG. 3, the figure shows an example current memory assignment, such as might occur from an initial memory assignment or due to runtime adjustments. As shown, four different compute nodes 300A, 300B, 300C and 300D each have 128 GB of native memory. In addition to the native memory, each node is assigned various amounts of memory from disaggregated memory pool 306, which is provisioned with 1 TB of pool memory. In the example, compute node 300A is assigned 256 GB of pool memory, compute node 300B is assigned 128 GB of pool memory, compute node 300C is assigned 384 GB of pool memory, and compute node 300D is assigned 64 GB of pool memory. The aggregate assignment is such that 960 GB of the provided 1 TB of disaggregated memory is assigned across the nodes. The number of compute nodes, as well as the amounts of native and disaggregated memory shown in FIG. 3 are non-limiting.

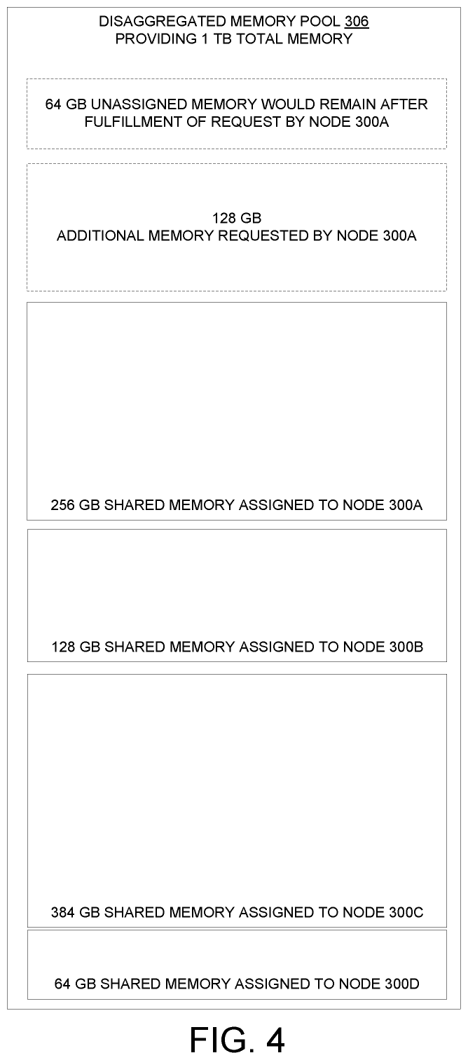

Returning to FIG. 2, method 200 includes, at 204, receiving a request to assign an additional portion (e.g., one or more additional slices) of the disaggregated memory pool to a requesting compute node of the compute nodes. Such a request may be seen with reference to FIG. 4, which shows an arrangement of memory in a schematic representation of portions of memory assigned to the different compute nodes. In particular, compute node 300A may request an additional 128 GB of memory from disaggregated memory pool 306 (e.g., such that compute node 300A would thereby be assigned a total of 384 GB of memory). Although FIG. 4 shows a schematic representation including sized blocks of memory, memory may be assigned in any suitable arrangement (e.g., contiguous and/or non-contiguous portions of memory, such as portions defined by one or more slices of memory, may be assigned to the compute nodes in a different order, and/or the compute nodes may each be assigned a plurality of non-contiguous portions). In the example of FIG. 4, the total amount of memory (e.g., 1 TB) in disaggregated memory pool 306 supports the 256 GB expansion for compute node 300A (e.g., after such assignment, the compute nodes would be collectively assigned 960 GB of the 1 TB of provided disaggregated memory). This assignment may represent significant memory pressure, e.g., because only 1/16 of the total available memory is unassigned and thereby available for subsequent assignment.

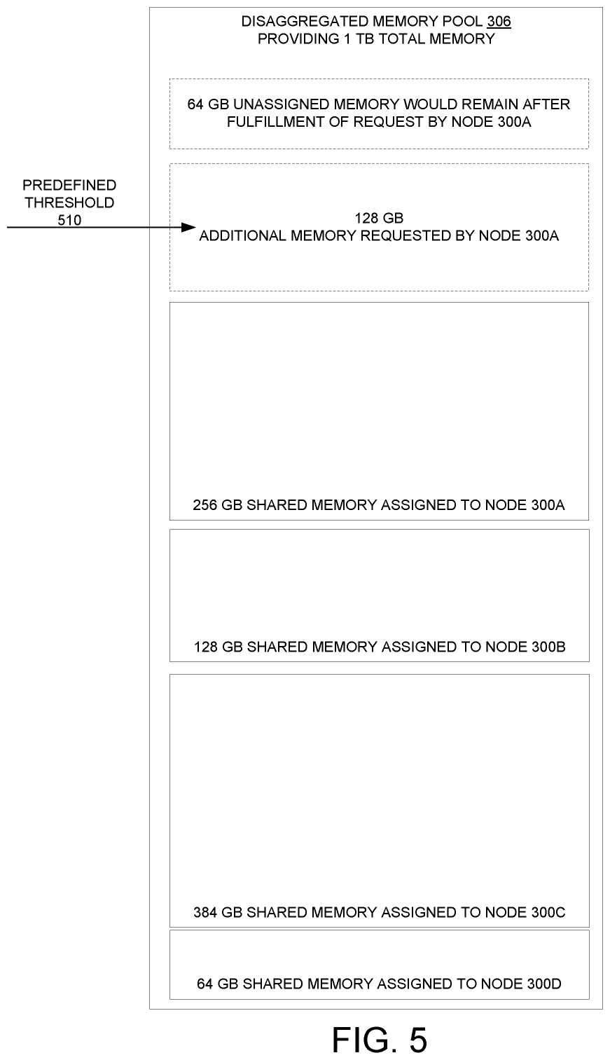

Returning to FIG. 2, method 200 includes, at 206, determining that the currently assigned total and the additional portion exceed a predefined threshold amount of the shared memory capacity. For example, a pooled memory controller may be configured to receive a request for the additional portion, and to compute a sum of the currently assigned total and the additional portion to the predefined threshold. Based on the comparison, the pooled memory controller may assess whether the currently assigned total, together with the additional portion, would likely incur memory pressure based on whether it exceeds the predefined threshold. One or more predefined thresholds may be defined in any suitable fashion (e.g., statically for the disaggregated memory pool and/or dynamically for different use cases, such as based on the hosts utilizing memory allocated by the disaggregated memory pool). In some examples, the pre-defined threshold may be configured by a human user (e.g., an administrator of a multi-host computer system). In other examples, the pre-defined threshold may be automatically assessed by the memory controller (e.g., based on an initial allocation and/or based on assessing a pattern of memory allocations and/or assignments, so as to assess when memory pressure is likely to occur). For example, the pre-defined threshold may be determined by operating a previously-trained machine learning system configured to assess memory pressure conditions. The predefined threshold may be defined in any suitable manner, for example as an amount of memory and/or as a percentage of available memory. For example, turning briefly to FIG. 5, a predefined threshold 510 may be 896 GB of the 1 TB of disaggregated memory. The example shown in FIG. 5 is non-limiting. The pre-defined threshold may be any suitable amount of the shared memory capacity, for example, indicating that memory pressure is likely to occur if further memory assignments are requested.

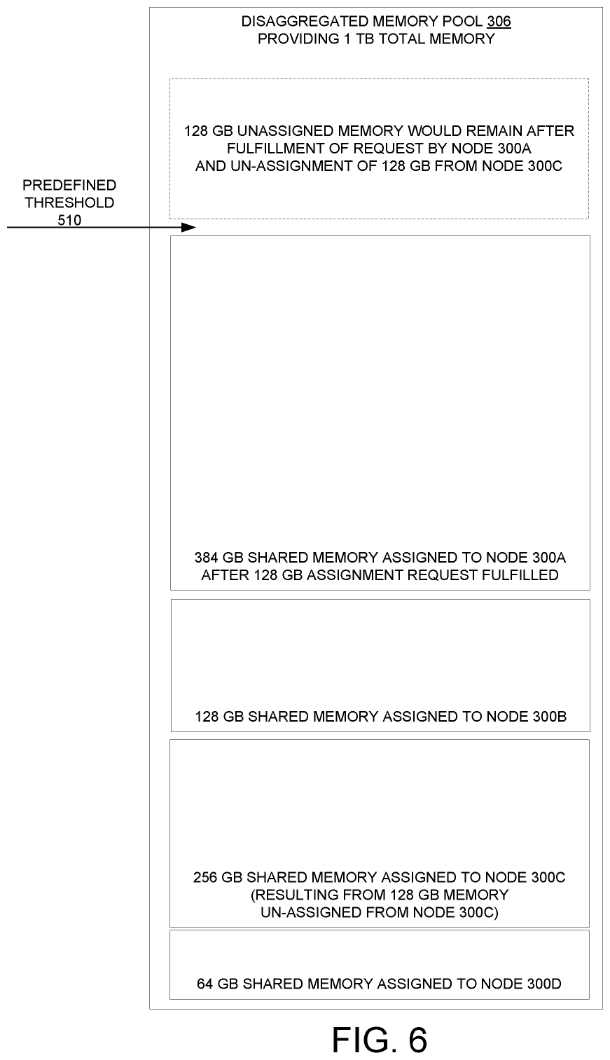

Returning to FIG. 2, method 200 includes, at 208, un-assigning an assigned portion of the disaggregated memory pool from one of the compute nodes (e.g., the same compute node that requested additional memory or a different compute node). For example, turning briefly to FIG. 6, compute node 300C may have 128 GB of memory un-assigned from it, thereby keeping the total assignments limited to 832 GB, which is under the predefined 896 GB threshold 510.

In some examples, un-assigning the assigned portion of the disaggregated memory pool includes requesting a compute node of the plurality of compute nodes to relinquish the assigned portion of the disaggregated memory pool. For example, the compute node may be configured to reduce a total assignment of memory, migrate data from the assigned portion into a different storage device, compress data from the assigned portion so as to consolidate the compressed data in a different portion, or any other suitable technique(s) for reducing overall memory usage so as to relinquish the assigned portion.

Although FIG. 6 shows memory being un-assigned from compute node 300C in order to permit further assignment of memory to compute node 300A, in some examples, memory already assigned to compute node 300A may be un-assigned (e.g., so as to free up that memory for subsequent assignment to other compute nodes). For example, the pooled memory controller may be configured, before or after providing compute node 300A with an additional portion of the disaggregated pool, to efficiently transfer data from a portion previously assigned to compute node 300A onto a different storage device so as to free up memory for subsequent assignment. As another example, the pooled memory controller may be configured to request that compute node 300A relinquish a previously-assigned portion before or after receiving the new requested portion (e.g., by transferring data to a different hardware device, compression). Accordingly, compute node 300A may be assigned new memory in which to store data, without increasing the overall burden on the disaggregated memory pool due to the new assignment.

In some examples, an unassigned portion of memory may be available for utilization. Accordingly, the unassigned portion may be assigned when memory is requested. In examples where memory is un-assigned, determining what portion to un-assign may be carried out according to any suitable replacement policy, for example, by assessing which assigned portion has been least-recently used (LRU). For example, a leaky-bucket counter may be implemented to track recency of access for portions of the disaggregated memory pool (e.g., the counter for each portion may be incremented when the portion is accessed and decremented gradually over time, so that a highest counter value represents a most recently used portion and a lowest counter value represents a least recently used portion).

Accordingly, a least-recently used portion may be un-assigned, with the LRU determination potentially reducing a likelihood that un-assignment will have a negative impact. For example, the least-recently used portion may have been assigned to a compute node that is primarily operating on different portions of memory and/or assigned to a compute node that is not currently performing as much memory-intensive computation as other compute nodes.

The pooled memory controller may maintain a segment table indicating different portions of the disaggregated memory pool that may be assigned/un-assigned, at any suitable granularity with regard to portion sizes. More generally, the pooled memory controller may maintain any suitable table representing available/assigned memory slices, indicating any relevant information pertaining to slices (e.g., assigned/unassigned status, ownership status indicating which compute node an assigned slice is assigned to, recency of use information, recency of assignment information, host type or other metadata pertaining to the compute node the assigned slice is assigned to). For example, for a 2 TB disaggregated memory pool, portions may be assigned/unassigned at a 1 GB slice granularity, e.g., there may be 2K (e.g., 2048) segments in the segment table indicating different 1 GB slices. As an example, a segment in the segment table may comprise a 32-bit segment identifier that includes 8 bits indicating a one-hot encoding of which host a portion is assigned to, a 1-bit value indicating whether the portion was ever accessed, a 3-bit decoder map indicating a target address decoding scheme for addressing data in the portion, and/or a 16-bit leaky bucket counter indicating a count value of recent accesses to the portion. For example, the segment table described above may comprise an 8 KB region of SRAM of the pooled memory controller. The above-described schema for a segment table is non-limiting, and the segment table may comprise any suitable data for tracking assignment of memory.

However the available memory is identified, it is then assigned so it can be used. Specifically, returning to FIG. 2, method 200 includes, at 210, assigning the additional portion of the disaggregated memory pool to the requesting compute node. Although FIG. 2 shows determining that the pre-defined threshold is exceeded at 206 followed by un-assigning an assigned portion of disaggregated memory at 208 and then assigning the additional portion of disaggregated memory at 210 (as requested at 204), it will be appreciated that these actions may be performed in any suitable order. For example, un-assigning memory may be performed pre-emptively (e.g., due to a logical determination of increasing memory pressure). Alternately or additionally, un-assigning memory may be deferred until after the assignment of memory at 210. For example, if there is sufficient memory to make a new assignment without first un-assigning memory, the new assignment may be made without first incurring a latency due to the nun-assigning operation. However, by un-assigning memory at some point after the new assignment, overall memory pressure may be kept tolerably low so that subsequent assignments are unlikely to be delayed due to memory pressure.

More generally, the techniques of the present disclosure may be used for actions including: 1) in response to an assessed level of memory pressure (e.g., after a new assignment request), de-assigning memory, moving evicted data from de-assigned memory into expanded bulk memory, consolidating evicted data in other assigned portions of disaggregated and/or native memory, etc.; 2) pre-emptively de-assigning memory, moving and/or consolidating evicted data, etc.; and/or 3) sending warning signals indicating a current level of memory pressure and/or a logically-determined estimation of future memory pressure to one or more compute nodes. In some examples, the pre-emptive de-assignment of memory may be performed responsive to an assignment request (e.g., before, after, or concurrent with assigning memory responsive to the assignment request). In other examples, the pre-emptive de-assignment of memory may be performed responsive to a logical assessment of current and/or expected memory pressure (e.g., periodically or based on any other schedule, and not necessarily connected to any particular assignment request).

For example, turning briefly to FIG. 6, the 128 GB portion requested by compute node 300A may be assigned before or after un-assigning the 128 GB portion from compute node 300C. In some examples, memory may be un-assigned from a first node before assigning requested memory to a second node (e.g., so that the total assignments remain below the predefined threshold). In other examples, memory may be assigned to the second node before and/or concurrently with the un-assignment of memory from the first node. For example, the second node may be assigned memory with little or no latency for accessing the assigned memory, and concurrently and/or subsequently, memory may be un-assigned from the first node so that the overall assignments do not exceed the predefined threshold or only briefly exceed the predefined threshold. Accordingly, latency of assigning memory may be minimized, while freeing up space to ensure minimal latency subsequent assignment of memory from the freed space. By un-assigning memory after the total assignment exceeds the pre-defined threshold, potential memory pressure on the memory system may be kept tolerable (e.g., subsequent assignments may be made without encountering prohibitive memory pressure).

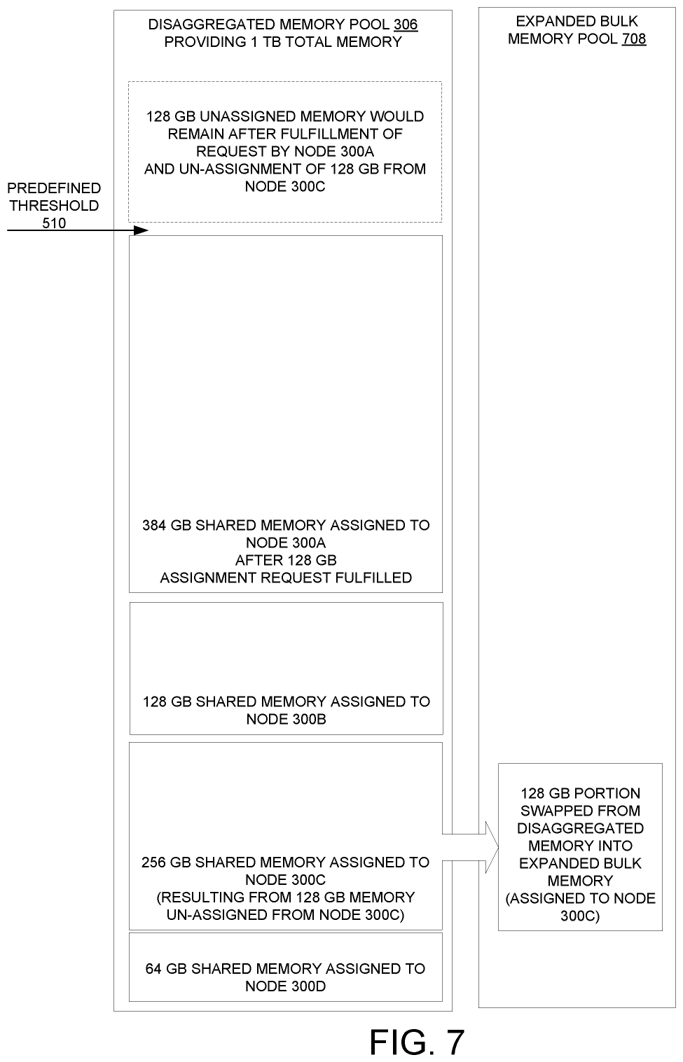

In some examples, un-assigning memory from the pool includes page-swapping data in the portion being un-assigned into an expanded bulk memory. FIG. 7 schematically depicts un-assignment of memory from a compute node by page-swapping a portion of assigned memory into an extended bulk memory 708. Swapping into the expanded bulk memory may be performed automatically by a hardware memory swap subsystem of the pooled memory controller to efficiently move data between the pool and expanded bulk memory 708.

Alternately or in addition to un-assigning memory from one or more compute nodes, warning signals may be sent in the event of memory pressure, such as when assignment/usage of the pool is above threshold. For example, when assignment in FIG. 5 exceeds the 896 GB threshold 510, the pooled memory controller may issue a warning signal to one or more compute nodes indicative of current or impending memory pressure. In response, nodes may take pre-emptive steps to limit current or upcoming memory usage (e.g., pre-emptively swapping data into an expanded bulk memory, compressing data, and/or any other suitable techniques as disclosed herein).

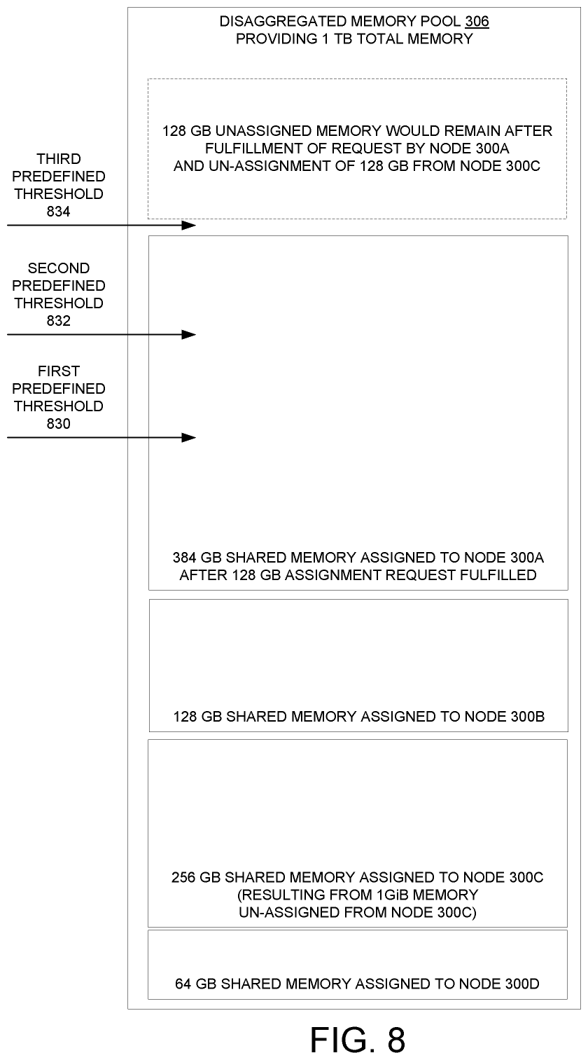

In some examples, various predefined thresholds indicating different levels of memory pressure may be determined (mild, medium, severe), with such levels being used to trigger different responsive operations. FIG. 8 schematically depicts different warning signals of varying severity. The figure shows a first predefined threshold 830 (e.g., 640 GB of memory assigned) corresponding to a first, pre-emptive warning; a second predefined threshold 832 (e.g., 768 GB of memory assigned) corresponding to a second, non-critical warning; and a third predefined threshold 834 (e.g., 896 GB of memory assigned) corresponding to a third, critical warning.

In this example, the compute nodes may be configured to respond to the first warning, second warning, and/or third warning by pre-emptively reducing memory usage (e.g., via swapping, compression, de-allocation) and/or by delaying/avoiding/reducing subsequent requested memory assignments. Accordingly, the compute nodes and pooled memory controller may cooperate to reduce the likelihood and/or effects of memory pressure. In one example, a compute node may respond to the first, pre-emptive warning signal by beginning a data compression process to reduce overall memory usage. Regarding the second, non-critical warning signal, the compute node may respond by swapping infrequently used data to a hard disk and/or to shared expanded bulk memory 708 via the hardware memory swap subsystem 720. As for the third, critical warning signal, a response may include de-allocating a page of memory. In general warning responses at a node may include reducing native and/or pool memory usage, compression, closing applications, swapping out data to disk or other storage, voluntarily relinquishing pool assignments, reducing requests to be assigned pool memory, etc.

In some examples, the pooled memory controller may be configured to send a subsequent relaxation signal when overall memory usage has been decreased (e.g., due to coordinated actions by the compute nodes). For example, if the overall memory assignment is reduced below the 640 GB first threshold, the pooled memory controller may be configured to issue a relaxation signal informing the compute nodes that the memory pressure has been reduced to a tolerable level, e.g., so that the compute nodes may resume normal requesting of subsequent memory assignments.

Sometimes, compute nodes may not relinquish memory when a request is made, for example in response to a node attempting to increase its pool assignment. For example, the compute node may have allocated the memory as a pinned I/O direct memory access region, or the memory may be otherwise pinned. In some cases, one or more compute nodes may refuse to relinquish memory (e.g., the compute nodes may fail to acknowledge a memory off-lining request issued by the pooled memory controller). In such cases, if there is no unassigned memory left in the disaggregated memory pool, a non-fatal warning signal may be issued to a compute node which requested an assignment in excess of available memory. At this point, the pooled memory controller may be configured to utilize expanded bulk memory, from which memory may be deterministically allocated. In some examples, a buffer region of the disaggregated memory pool may be used as a cache for data in the expanded bulk memory. This approach may enable continued assignment of memory even in excess of the total memory available in the disaggregated memory pool. However, it will be appreciated that due to increased latency of accessing the expanded bulk memory, the continued assignment of memory in excess of the disaggregated memory pool may result in suboptimal performance. Accordingly, the compute node may be configured to respond to the non-fatal warning signal by “backing off” and reducing overall memory utilization.

The examples disclosed herein are non-limiting. A pooled memory controller according to the present disclosure may determine any suitable predefined threshold amount(s) of memory indicating various levels of memory pressure. Accordingly, the pooled memory controller and compute nodes may cooperate to reduce memory pressure when such predefined threshold amount(s) are exceeded, e.g., via any suitable combination of relinquishment of assigned memory by a compute node, page-swapping into expanded bulk memory, and/or any other suitable hardware and/or software technique(s) for reducing overall memory usage so as to mitigate the memory pressure.

In some embodiments, the methods and processes described herein may be tied to a computing system of one or more computing devices. In particular, such methods and processes may be implemented as a computer-application program or service, an application-programming interface (API), a library, and/or other computer-program product.

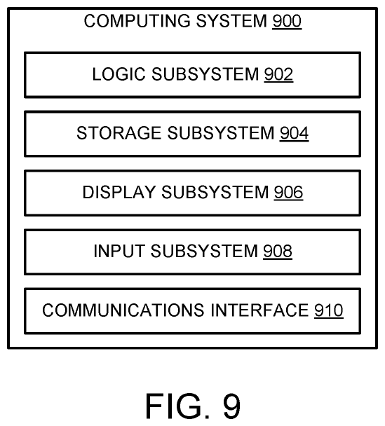

FIG. 9 schematically shows a simplified representation of a computing system 900 configured to provide any to all of the compute functionality described herein. Computing system 900 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 900 includes a logic subsystem 902 and a storage subsystem 904. Computing system 900 may optionally include a display subsystem 906, input subsystem 908, communication subsystem 910 and/or other subsystems not shown in FIG. 9.

Logic subsystem 902 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 904 includes one or more physical devices configured to temporarily and/or permanently hold computer information such as data and instructions executable by the logic subsystem. When the storage subsystem includes two or more devices, the devices may be collocated and/or remotely located. Storage subsystem 904 may include volatile, nonvolatile, dynamic, static, read/write, read-only, random-access, sequential-access, location-addressable, file-addressable, and/or content-addressable devices. Storage subsystem 904 may include removable and/or built-in devices. When the logic subsystem executes instructions, the state of storage subsystem 904 may be transformed—e.g., to hold different data.

Aspects of logic subsystem 902 and storage subsystem 904 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 906 may be used to present a visual representation of data held by storage subsystem 904. This visual representation may take the form of a graphical user interface (GUI). Display subsystem 906 may include one or more display devices utilizing virtually any type of technology. In some implementations, display subsystem may include one or more virtual-, augmented-, or mixed reality displays.

When included, input subsystem 908 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 910 may be configured to communicatively couple computing system 900 with one or more other computing devices. Communication subsystem 910 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a thin-provisioned multi-node computer system comprises: a disaggregated memory pool configured to make a shared memory capacity available to each of a plurality of compute nodes. In this or any other example, the thin-provisioned multi-node computer system further comprises a pooled memory controller configured to: assign, to each compute node of the plurality of compute nodes, a portion of the disaggregated memory pool such that a currently assigned total of assigned portions of the disaggregated memory pool is less than the shared memory capacity; receive a request to assign an additional portion of the disaggregated memory pool to a requesting compute node of the compute nodes, such that the currently assigned total and the additional portion would exceed a predefined threshold amount of the shared memory capacity; un-assign an assigned portion of the disaggregated memory pool; and assign the additional portion of the disaggregated memory pool to the requesting compute node to satisfy the request. In this or any other example, a memory allocation of a compute node of the plurality of compute nodes exceeds a sum of 1) a native memory capacity of the compute node and 2) an assigned portion of the disaggregated memory pool for the compute node. In this or any other example, each of the compute nodes has a native memory capacity, and wherein a total memory allocation of the plurality of compute nodes exceeds a physical memory sum of 1) the shared memory capacity and 2) a total native memory capacity for all of the plurality of compute nodes. In this or any other example, un-assigning the assigned portion of the disaggregated memory pool includes requesting a compute node of the plurality of compute nodes to relinquish the assigned portion of the disaggregated memory pool. In this or any other example, un-assigning the assigned portion of the disaggregated memory pool is based on a replacement policy for the disaggregated memory pool. In this or any other example, un-assigning the assigned portion of the disaggregated memory pool includes page-swapping data in the assigned portion of the disaggregated memory pool into an expanded bulk memory. In this or any other example, page-swapping the assigned portion of the disaggregated memory pool into the expanded bulk memory is performed automatically by a hardware memory swap subsystem of the pooled memory controller. In this or any other example, a compute node of the plurality of compute nodes includes a non-uniform memory access (NUMA)-aware memory controller configured to optimize a memory slice layout in native memory of the compute node, the disaggregated memory pool, and the expanded bulk memory. In this or any other example, the pooled memory controller is further configured, based on the total assignment of the disaggregated memory pool exceeding the predefined threshold amount, to send a warning signal to one or more of the plurality of compute nodes. In this or any other example, the plurality of compute nodes are connected to the pooled memory controller via a high-throughput bus. In this or any other example, a current assignment of the disaggregated memory pool is an initial static assignment for the plurality of compute nodes made during a boot process of the thin-provisioned multi-node computer system. In this or any other example, the initial static assignment made during the boot process is based on a machine learning prediction of expected memory usage by each compute node of the plurality of compute nodes.

In an example, a method of thin-provisioning memory for a multi-node computer system comprises: assigning, to each compute node of a plurality of compute nodes, a portion of a disaggregated memory pool configured to provide a shared memory capacity to the plurality of compute nodes, such that a currently assigned total of assigned portions of the disaggregated memory pool is less than the shared memory capacity; receiving a request to assign an additional portion of the disaggregated memory pool to a requesting compute node of the compute nodes, such that the currently assigned total and the additional portion would exceed a predefined threshold amount of the shared memory capacity; un-assigning an assigned portion of the disaggregated memory pool; and assigning the additional portion of the disaggregated memory pool to the requesting compute node to satisfy the request. In this or any other example, un-assigning the assigned portion of the disaggregated memory pool includes requesting a compute node of the plurality of compute nodes to relinquish the assigned portion of the disaggregated memory pool. In this or any other example, un-assigning the assigned portion of the disaggregated memory pool includes identifying a least-recently used portion of the disaggregated memory pool. In this or any other example, un-assigning the assigned portion of the disaggregated memory pool includes page-swapping the assigned portion of the disaggregated memory pool into an expanded bulk memory. In this or any other example, page-swapping the assigned portion of the disaggregated memory pool into the expanded bulk memory is performed automatically by a hardware memory swap subsystem.

In an example, a thin-provisioned multi-node computer system comprises: a plurality of compute nodes, wherein each compute node has a native memory providing a native memory capacity; a disaggregated memory pool configured to make a shared memory capacity available to each of the plurality of compute nodes; and a pooled memory controller configured to: assign, to each compute node of the plurality of compute nodes, a portion of the disaggregated memory pool such that a currently assigned total of assigned portions of the disaggregated memory pool is less than the shared memory capacity; receive a request to assign an additional portion of the disaggregated memory pool to a requesting compute node of the compute nodes, such that the currently assigned total and the additional portion would exceed a predefined threshold amount of the shared memory capacity; un-assign an assigned portion of the disaggregated memory pool; and assign the additional portion of the disaggregated memory pool to the requesting compute node to satisfy the request. In this or any other example, the computer system further comprises an expanded bulk memory, wherein un-assigning the assigned portion of the disaggregated memory pool includes page-swapping the assigned portion of the disaggregated memory pool into the expanded bulk memory. In this or any other example, a compute node of the plurality of compute nodes includes a non-uniform memory access (NUMA)-aware memory controller configured to optimize a memory slice layout in native memory of the compute node, the disaggregated memory pool, and the expanded bulk memory.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A thin-provisioned multi-node computer system, comprising:
a disaggregated memory pool configured to make a shared memory capacity available to each of a plurality of compute nodes;
a pooled memory controller configured to:
assign, to each compute node of the plurality of compute nodes, a portion of the disaggregated memory pool such that a currently assigned total of assigned portions of the disaggregated memory pool is less than the shared memory capacity;
receive a request to assign an additional portion of the disaggregated memory pool to a requesting compute node of the compute nodes, such that the currently assigned total and the additional portion would exceed a predefined threshold amount of the shared memory capacity;
un-assign an assigned portion of the disaggregated memory pool; and
assign the additional portion of the disaggregated memory pool to the requesting compute node to satisfy the request.

2. The computer system of claim 1, wherein a memory allocation of a compute node of the plurality of compute nodes exceeds a sum of 1) a native memory capacity of the compute node and 2) an assigned portion of the disaggregated memory pool for the compute node.

3. The computer system of claim 1, wherein each of the compute nodes has a native memory capacity, and wherein a total memory allocation of the plurality of compute nodes exceeds a physical memory sum of 1) the shared memory capacity and 2) a total native memory capacity for all of the plurality of compute nodes.

4. The computer system of claim 1, wherein un-assigning the assigned portion of the disaggregated memory pool includes requesting a compute node of the plurality of compute nodes to relinquish the assigned portion of the disaggregated memory pool.

5. The computer system of claim 1, wherein un-assigning the assigned portion of the disaggregated memory pool is based on a replacement policy for the disaggregated memory pool.

6. The computer system of claim 1, wherein un-assigning the assigned portion of the disaggregated memory pool includes page-swapping data in the assigned portion of the disaggregated memory pool into an expanded bulk memory.

7. The computer system of claim 6, wherein page-swapping the assigned portion of the disaggregated memory pool into the expanded bulk memory is performed automatically by a hardware memory swap subsystem of the pooled memory controller.

8. The computer system of claim 6, wherein a compute node of the plurality of compute nodes includes a non-uniform memory access (NUMA)-aware memory controller configured to optimize a memory slice layout in native memory of the compute node, the disaggregated memory pool, and the expanded bulk memory.

9. The computer system of claim 2, wherein the pooled memory controller is further configured, based on the total assignment of the disaggregated memory pool exceeding the predefined threshold amount, to send a warning signal to one or more of the plurality of compute nodes.

10. The computer system of claim 1, wherein the plurality of compute nodes are connected to the pooled memory controller via a high-throughput bus.

11. The computer system of claim 1, wherein a current assignment of the disaggregated memory pool is an initial static assignment for the plurality of compute nodes made during a boot process of the thin-provisioned multi-node computer system.

12. The computer system of claim 11, wherein the initial static assignment made during the boot process is based on a machine learning prediction of expected memory usage by each compute node of the plurality of compute nodes.

13. A method of thin-provisioning memory for a multi-node computer system, the method comprising:
assigning, to each compute node of a plurality of compute nodes, a portion of a disaggregated memory pool configured to provide a shared memory capacity to the plurality of compute nodes, such that a currently assigned total of assigned portions of the disaggregated memory pool is less than the shared memory capacity;
receiving a request to assign an additional portion of the disaggregated memory pool to a requesting compute node of the compute nodes, such that the currently assigned total and the additional portion would exceed a predefined threshold amount of the shared memory capacity;
un-assigning an assigned portion of the disaggregated memory pool; and
assigning the additional portion of the disaggregated memory pool to the requesting compute node to satisfy the request.

14. The method of claim 13, wherein un-assigning the assigned portion of the disaggregated memory pool includes requesting a compute node of the plurality of compute nodes to relinquish the assigned portion of the disaggregated memory pool.

15. The method of claim 13, wherein un-assigning the assigned portion of the disaggregated memory pool includes identifying a least-recently used portion of the disaggregated memory pool.

16. The method of claim 13, wherein un-assigning the assigned portion of the disaggregated memory pool includes page-swapping the assigned portion of the disaggregated memory pool into an expanded bulk memory.

17. The method of claim 16, wherein page-swapping the assigned portion of the disaggregated memory pool into the expanded bulk memory is performed automatically by a hardware memory swap subsystem.

18. A thin-provisioned multi-node computer system, comprising:
a plurality of compute nodes, wherein each compute node has a native memory providing a native memory capacity;
a disaggregated memory pool configured to make a shared memory capacity available to each of the plurality of compute nodes; and
a pooled memory controller configured to:
assign, to each compute node of the plurality of compute nodes, a portion of the disaggregated memory pool such that a currently assigned total of assigned portions of the disaggregated memory pool is less than the shared memory capacity;
receive a request to assign an additional portion of the disaggregated memory pool to a requesting compute node of the compute nodes, such that the currently assigned total and the additional portion would exceed a predefined threshold amount of the shared memory capacity;
un-assign an assigned portion of the disaggregated memory pool; and
assign the additional portion of the disaggregated memory pool to the requesting compute node to satisfy the request.

19. The computer system of claim 18, further comprising an expanded bulk memory, wherein un-assigning the assigned portion of the disaggregated memory pool includes page-swapping the assigned portion of the disaggregated memory pool into the expanded bulk memory.

20. The computer system of claim 19, wherein a compute node of the plurality of compute nodes includes a non-uniform memory access (NUMA)-aware memory controller configured to optimize a memory slice layout in native memory of the compute node, the disaggregated memory pool, and the expanded bulk memory.
